(19) United States
(12) Patent Application Publication
(10) Pub. No.: US 2005/0055251 A1
(43) Pub. Date: Mar. 10, 2005

(54) Cost-effective benefit plan system and method

(75) Inventors: William M. Ashley, Spring Hill, KS (US); Jeffrey D. Miller, Overland Park, KS (US)

Correspondence Address: CHASE LAW FIRM L.C, 4400 COLLEGE BOULEVARD, SUITE 130, OVERLAND PARK, KS, 66211, US

(73) Assignee: Allied National, Inc., Kansas City, MO (US)

(21) Appl. No.: 10/928,694

(22) Filed: Aug. 27, 2004

Related U.S. Application Data
(60) Provisional application No. 60/498,797, filed on Aug. 29, 2003.

(51) Int. Cl. G06F 17/60

(52) U.S. Cl. 705/4

(57) ABSTRACT

A benefit plan system is provided with multiple categories of benefits. The benefits are subject to controls, which are independently variable. The controls can comprise one or more of limit amounts, deductible amounts, coinsurance percentages and copay amounts. A catastrophic attachment point (CAP) can represent a predetermined incurred expense amount, a medical condition or some other criteria. Major medical benefits can be available upon reaching the CAP, and likewise have independently variable controls. A benefit method is provided in includes the steps of providing limited medical benefits, assigning independently variable controls, providing a CAP, providing major medical benefits when incurred expenses exceed the CAP and negotiating with healthcare providers for favorable pricing within said controls. Additional CAPs can be provided, and can correspond to other criteria such as medical conditions, etc.

### CROSS-REFERENCE TO RELATED APPLICATION

This application claims the benefit of U.S. provisional application No. 60/498,797, filed Aug. 29, 2003, which is incorporated herein by reference.

### BACKGROUND OF THE INVENTION

1. Field of the Invention

The present invention relates generally to benefit plans, and in particular to a cost-effective health care benefit system and method utilizing a limited or “supplemental” benefit medical plan, either stand alone or in conjunction with optional benefits to enhance coverage, including but not limited to an optional major medical plan.

2. Description of Related Art

A wide variety of benefit systems and methods have previously been developed for insuring against expenses and losses. For example, numerous health insurance plans are available for providing health care benefits. Premiums and benefits vary considerably among the products offered by different insurance and benefit service providers.

In recent years the nation's health care system has experienced significant cost increases. Such increases are attributable to a number of factors, including increasingly expensive medical procedures and prescription medications and legislatively mandated benefits. Health insurance cost and availability are sources of major concern for parties responsible for medical costs and health insurance premiums, including employers who provide such benefits and their employees/insureds. Areas of concern commonly involve premiums, coverage and health care service provider choices.

Traditional indemnity fee-for-service (FFS) health insurance plans provide comprehensive coverage with “first dollar” benefits, i.e. insurance payment of the initial expenses for doctors' offices visits, prescription medications, etc. Comprehensive, traditional medical insurance policies with “first dollar” benefits, high benefit limits, low deductibles and minimal exclusions are available, but tend to be too expensive for many employers.

Health insurance and benefit plan providers have responded to rising health care costs by increasing premiums, restricting availability and reducing coverage in order to provide affordable health insurance and benefit plan products. For example, increasing deductible amounts is a common strategy for reducing insurance premiums. However, considerable employee resistance to such increases can be encountered, because employees' health care costs are out-of-pocket until expenses exceed the deductible amounts. Therefore, absent “first dollar” benefits for such routine services as doctors' office visits and prescription medications, employees tend to disfavor high-deductible health insurance policies.

Other cost control measures include reducing the ongoing and cumulative maximum benefit amounts associated with different types of services. Such reductions normally have no effect on most insureds, who typically do not incur the maximum benefit amounts during any given reporting period. However, a number of serious or “catastrophic” illnesses, injuries and conditions can exhaust available benefits, effectively leaving the insureds without coverage. Therefore, relatively low maximum benefit limits are disfavored by some because of the possibility of a catastrophic and financially ruinous claim, but accepted by others seeking cost-effective benefits.

Cost control measures have also been directed towards the providers of health care services and pharmaceuticals. Managed care plans, including preferred provider organizations (PPOs) and health maintenance organizations (HMOs), have resulted in more affordable fee and cost structures being negotiated among insurance providers, health care service providers and pharmaceutical companies. However, stringent forms of managed care, which reduce the consumers' options in where and how to receive care, are meeting increased resistance. Federal and state governments have addressed the cost and availability of health care with legislation, regulations and requirements, which control various aspects of the industry and its delivery of services and pharmaceuticals.

Notwithstanding the wide variety of insurance benefits products and widespread public and private efforts to curb the escalating costs of health care, most insureds have little or no direct involvement in health care pricing. Absent self-direction of their benefits, they generally lack any direct incentive to seek and negotiate favorable pricing for needed treatments and pharmaceuticals and to exercise control over consumption. Such pricing is commonly, and often incorrectly, perceived as “fixed”, and therefore not subject to negotiation. Providing the insureds with some degree of self-direction of their benefits plans and self-selection of care providers, with cost-effectiveness incentives, may contribute to controlling health care costs.

Health insurance cost increases, coupled with employee resistance to loss of first dollar benefits through high deductibles and increased out-of-pocket expenses, have driven many employers away from providing health insurance for their employees. For example, in the year 2000 only approximately 58 percent of businesses with three to nine employees offered health insurance. Moreover, approximately 20 percent of the estimated 39 million Americans without health coverage declined employer-based coverage, primarily because of affordability. More than 80 percent of the uninsured live in working families. Therefore, a significant demand exists for affordable coverage, particularly with such preferred features as first dollar benefits for office visits, emergency room visits and pharmaceuticals. More affordable health insurance plans may lead to greater numbers of insureds and fewer uninsured individuals, thus helping avoid the transfer of costs from those unable to pay to those with health insurance.

Health insurance plans preferably provide some flexibility for their insureds who may elect to obtain additional coverage. For example, beyond a limited or supplemental benefit plan, additional coverage for “major medical” expenses can be added as an optional plan, to insure against serious or catastrophic illnesses, injuries and conditions, such as critical illnesses, dread diseases and cancer. In order to cover such expenses, a major medical benefit plan can “attach” at a predetermined expenditure level. “Supplements” typically pay on first dollar claims. A common supplemental insurance product for enhancing coverage is a critical illness/dread disease/cancer plan that pays a lump sum upon diagnosis. The availability of such optional, supplemental benefit plans beyond first dollar coverage can provide insureds with some control over their health care insurance costs and coverages. Additionally, many legislated mandates do not apply to limited or supplemental plans.

Heretofore there has not been available a benefit plan system and method with the advantages and features of the present invention.

### BRIEF DESCRIPTION OF THE INVENTION

In the practice of one aspect of the present invention, a limited or supplemental health care benefit plan system is provided for paying benefits based on particular benefit formulas corresponding to types of services provided and expenses incurred. First dollar and copay benefits can be utilized for such routine benefits as doctors' office visits and prescription medications. In the practice of another aspect of the present invention, a catastrophic attachment point (CAP) can represent a predetermined maximum amount of medical expenditures allowed under a limited or supplemental benefit plan during a particular time period, beyond which additional benefits become available under a major medical benefit plan. In fact, the CAP must be satisfied under the “first dollar” plan before “catastrophic” benefits become available. Other CAP criteria can include diagnosis of particular medical conditions, which trigger the supplemental coverage exceeding the CAP. Other aspects of the present invention follow a similar practice of adding various benefit options to the limited or supplemental plan. Automatic incentives are provided for encouraging self-direction and self-selection by the insureds and their employers in connection with selecting appropriate benefit plans and procuring health care services and pharmaceuticals using such benefit plans economically. In the practice of the method of the present invention, benefit variables are determined according to certain factors, and patients/insureds exercise control over coverage options and participate in procuring health care in order to most effectively and efficiently utilize their health care benefits.

### BRIEF DESCRIPTION OF THE DRAWINGS

The drawings constitute a part of this specification and include exemplary embodiments of the present invention and illustrate various objects and features thereof.

FIG. 1 is a bar chart showing the payment allocations for different types of medical claims under a limited plan and, by way of example, an optional major medical plan in a system embodying the present invention.

FIG. 2 is a flowchart showing the design of the system in two stages for a limited plan and, by way of example, an optional major medical plan.

FIG. 3 is a flowchart showing the implementation of the system with an optional plan.

FIG. 4 is a flowchart showing the application of various cost factors by the system with an optional plan in connection with a particular claim.

FIG. 5 is a medical benefit highlights chart for the limited plan, optional major medical plan and prescription drug components of the system.

### DETAILED DESCRIPTION OF THE INVENTION

### Introduction

As required, detailed embodiments and/or aspects of the present invention are disclosed herein; however, it is to be understood that the disclosed embodiments/aspects are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriate system or method.

### Benefit System and Method Description

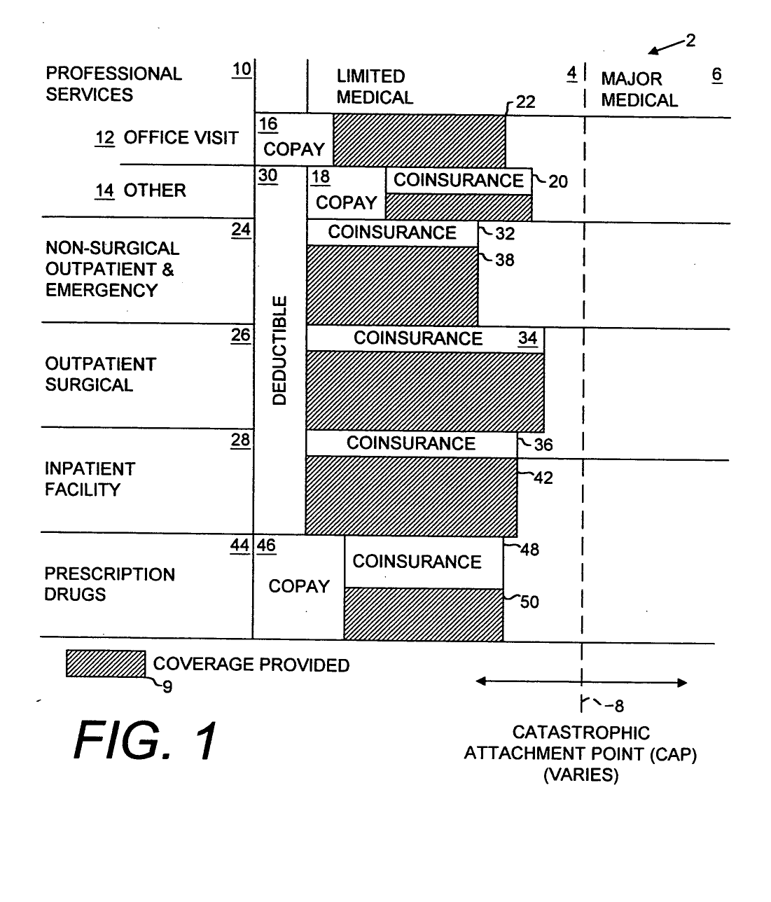

Referring to the drawings in more detail, the reference numeral 2 generally designates a benefit system embodying the present invention with an optional major medical plan. Without limitation on the generality of useful applications of the system 2, a medical benefits system is shown and described by way of example. As shown in FIG. 1, the system 2 generally comprises a limited benefit medical plan 4 with the options of additional integrated benefits, such as an optional major medical plan 6 for attachment at a variable catastrophic attachment point (CAP) 8.

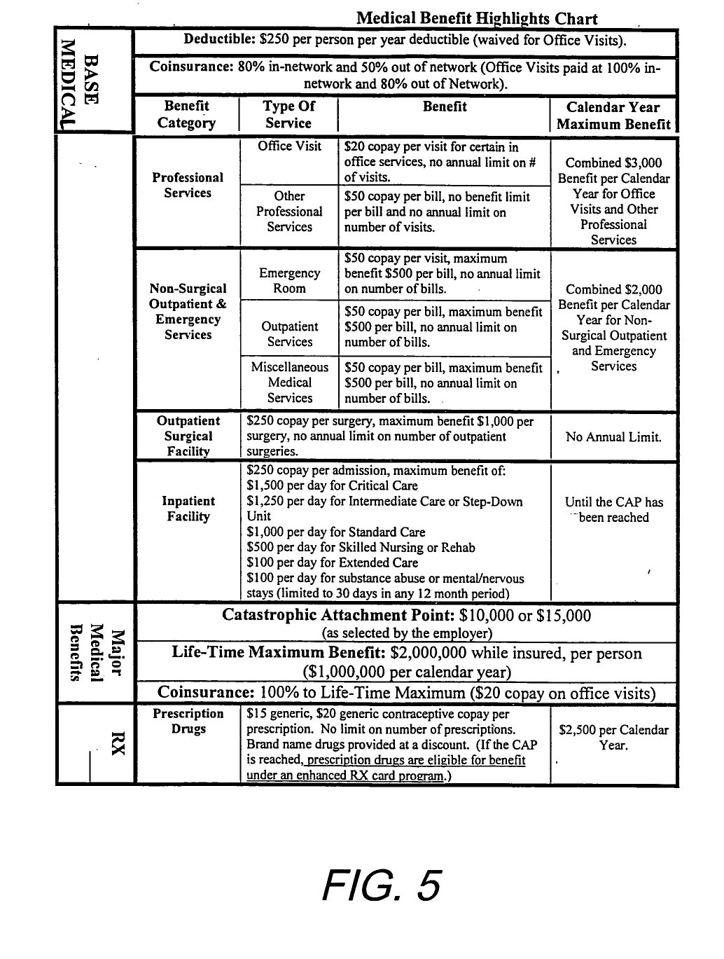

Cost allocations under the system 2 can be based on services provided, but other categorization criteria can be used, such as diagnosed patient conditions. The shaded areas 9 represent those portions of the costs which are covered by the plan. A professional services category or “corridor” 10 includes doctors' office visits 12 and other professional services 14. As shown, different cost allocation formulas can be applied to “Office Visit” versus “Other” professional services. For example, a relatively low copay 16 can apply to in-network office visits with the deductible waived and no coinsurance, whereby the insured realizes “first dollar” benefits. By way of example, the Medical Benefit Highlights Chart (FIG. 5) shows a $20 copay per office visit, with 100 percent coinsurance in-network and 80 percent coinsurance out-of-network. Moreover, a deductible 30 (e.g. $250 per person per year) can be waived for office visits. Other professional services 14 can involve a different copay 18 amount (e.g. $50), coinsurance 20 at a predetermined percentage (e.g. 80 percent in-network and 50 percent out-of-network) and be subject to the deductible 30. Maximum payments per visit may or may not apply, and a combined total yearly benefit 22 (e.g. $3000) for all professional services 10 represents the maximum benefit payment per year in connection with this category.

The categories comprising non-surgical outpatient and emergency 24, outpatient surgical 26 and inpatient facility 28 are subject to the deductible amount 30 and coinsurance 32, 34, 36 respectively and maximum yearly benefit amounts 38, 40, 42 respectively, which can vary among the different categories. A prescription drugs category 44 can also involve a copay amount 46, optional coinsurance 48 and a yearly maximum benefit amount 49. For example, the benefit coverage for generic drugs can be 100 percent after copay, with a lesser percent for “brand-name” drugs when chosen by a patient over the generic equivalent. Other benefit plans and procedures can be employed in connection with prescription medications, such as discounts or predetermined payment amounts according to applicable medication benefit schedules.

The limited benefit medical plan 4 provides the ability to vary: a) the service categories upon which benefits are determined; and b) the determination of the benefits in each category by varying the copay, deductible, and maximum benefit amounts and the coinsurance percentages. Purchasers of the plan 4 can thus meet their cost-benefit objectives. In contrast to plans that control premiums by adjusting deductible amounts (lower premiums with higher deductibles and vice versa), the present plan allows for the selection of benefits to optimize the perceived value of the benefits provided for the target premiums. The variation of these values can occur beginning at the first dollar, or at any other point. Such variable, buyer-controlled values are not required to be contiguous but are discreet, independent attributes.

### Catastrophic Attachment Point (CAP) 8 and Optional Major Medical Plan 6

The CAP 8 can be defined by various criteria, including the diagnosis of a particular medical condition or by expenses incurred under the limited benefit medical plan 4, irrespective of whether or not and to what extent they comprise covered versus patient out-of-pocket expenses. Multiple CAPs can be utilized corresponding to various respective criteria corresponding to patient conditions, expenditures, etc. For example, the CAP amount 8 can be adjusted to control the premiums associated with the major medical plan 6, with a relatively low amount involving higher premiums and vice versa. The insured and/or the employer can select a major medical plan 6, which provides sufficient protection against a catastrophic illness, injury or condition, with affordable and otherwise acceptable premium and CAP amounts. Unlike traditional offerings where a limited or supplemental plan is purchased in conjunction with a comprehensive “catastrophic” major medical plan, the CAP allows for a seamless, non-overlapping integration of the limited and major medical benefits.

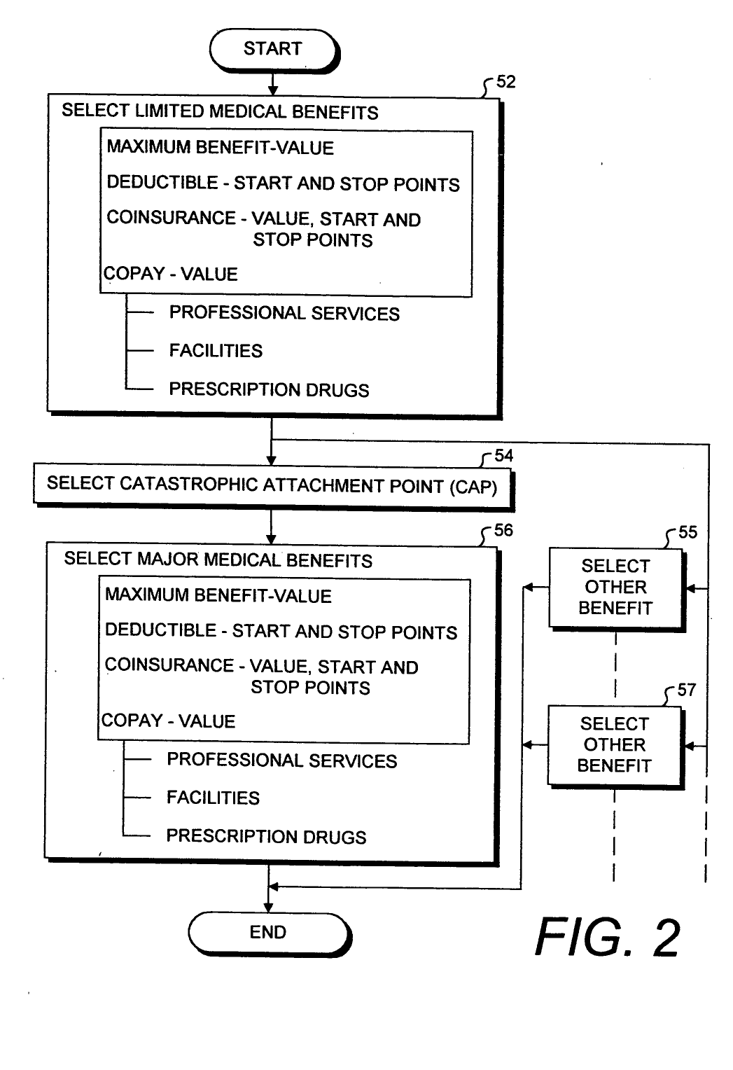

FIG. 2 shows the factors to be considered in connection with designing the benefit system 2, wherein the limited medical benefits are selected at 52, the CAP amount is selected at 54 and the major medical benefits are selected at 56. Alternatively, the system 2 can branch to Select Other Benefit 55, 57 ahead of the CAP 54. Such other benefits 55, 57 can comprise, for example, a supplemental plan(s) for lump sum payments in the event of a particular diagnosis, such as a critical illness, a dread disease or cancer. Such other benefits 55, 57 may apply irrespective of reaching the CAP amount 8.

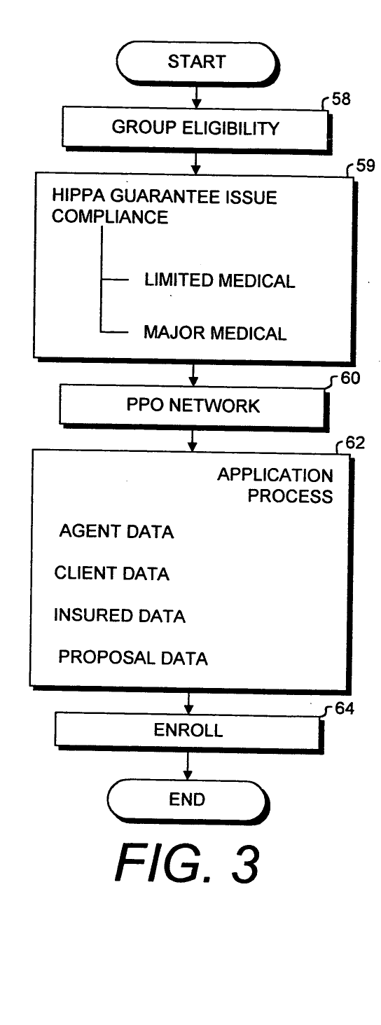

FIG. 3 shows the process for implementing the system 2, with group eligibility being determined at 58. In some states HIPAA “guaranteed issue” requirements apply, and can be satisfied by making available either the limited benefit medical plan 4 or the major medical plan 6, as indicated at 59. A preferred provider organization (“PPO”) network is identified at 60. The application process occurs at 62 and involves the submission of agent data, client data, insured data and proposal data to the plan administrator, which typically accepts plans if medical underwriting is not required, or otherwise submits them to medical underwriters. Upon completion of the application process 62, the insureds are enrolled at 64.

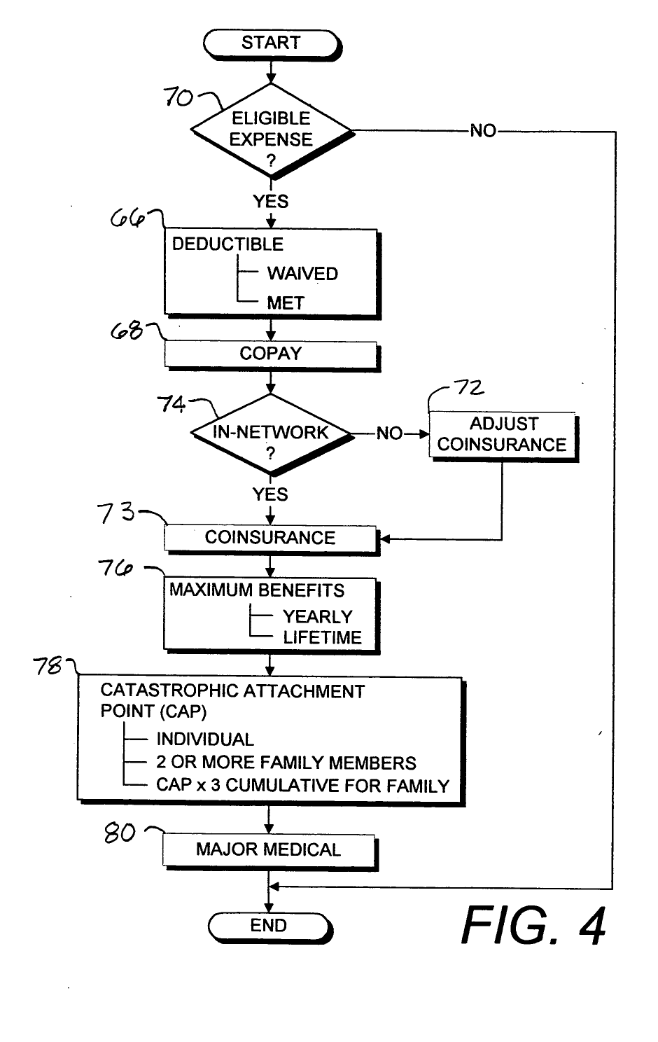

FIG. 4 shows the processing of a typical claim. An “eligible expense” decision box 70 leads to termination of the evaluation in the event of a negative response, i.e. the claim is excluded or otherwise ineligible. Such excluded claims typically will not apply towards deductibles and the CAP amount 8. A positive response leads to the application of a deductible at 66, which can be waived, e.g. for office visits and prescription medications. For certain categories, the plan begins paying benefits after predetermined deductibles are met. A copay (if any) is applied at 68 and the care provider is evaluated at decision box 74, based on being either “in-network” (positive branch) or “out-of-network” (negative branch), the latter generally leading to a coinsurance percentage adjustment (normally an increase) at 72 and greater participation by the insured in the cost of obtaining out-of-network health care. Moreover, expenses for out-of-network services are typically applied at 50 percent towards the CAP 8, whereas in-network service providers' charges apply at 100 percent in order to encourage use of the PPO network.

Coinsurance is applied at 73. Maximum benefits (yearly and lifetime) limits are applied at 76. The CAP 8 calculation is performed at 78 based on all eligible expenses (whether covered or not), with appropriate adjustments for in/out of network. The CAP can apply individually, or collectively for a family whereby two or more family members reaching the CAP or cumulative family expenses (regardless of the number of family members incurring expenses) of three times the CAP will activate major medical coverage at 80.

FIG. 5 comprises a medical benefit highlights chart for an embodiment or aspect of the system, including the optional major medical plan 6.

The multiple tier configuration of the system 2 provides significant advantages. For example, the limited benefit medical plan 4 provides the insureds with first dollar benefits and coverage for typical, routine medical services and prescription medications. Premiums can be relatively affordable if the yearly maximums (i.e. 22, 38, 40, 42 and 48) are adequate for commonly-occurring, routine health care services and below the costs of catastrophic illnesses, injuries and conditions, which the insureds or their employers can optionally elect to cover with the major medical plan 6. Moreover, the maximums can provide an incentive for the insureds to participate in procuring reasonably-priced health care services. For example, a health care provider might agree to accept the maximum benefits payments under the limited benefit medical plan 4 as full payment. The insureds can take advantage of the disparities in service provider charges in connection with making informed choices within the budgetary constraints set by the limited benefit medical plan 4. Still further, the limited benefit medical plan 4 need not be medically underwritten, thus avoiding restrictions and requirements imposed by medical underwriters. The optional major medical plan 6, on the other hand, can be medically underwritten independently of the limited benefit medical plan 4.

As noted above, the CAP 8 can be chosen to balance premium affordability and a desired level of protection against a catastrophic medical event, if for example the major medical option is added. Such a two-tier system, with a variable CAP 8 for a transition therebetween, provides virtually unlimited permutations and combinations of overall benefit systems, which can be tailored to meet the objectives of both employers and insureds. Moreover, the system 2 can be adapted to other forms of insurance and indemnification, especially where other optional benefit plans (e.g. 55, 57), alone or in combination, can be advantageously added to the limited coverage plan 4.

It is to be understood that while certain embodiments and/or aspects of the invention have been shown and described, the invention is not limited thereto and encompasses various other embodiments/aspects.

1. A benefit plan system, which comprises:
a first benefit category;
a second benefit category;
a first benefit control on said first benefit category;
a second benefit control on said second benefit category; and
said first and second benefit controls being independently variable.

2. The benefit plan system according to claim 1 wherein said first and second benefit controls are chosen from the group consisting of copay amount, coinsurance percentage, deductible amount and limit amount.

3. The benefit plan system according to claim 2, which includes:
multiple said benefit controls on each said benefit category.

4. The benefit plan system according to claim 3, which includes:
said first benefit category having copay and limit amount controls; and
said second benefit category having deductible amount and coinsurance percentage controls.

5. The benefit plan system according to claim 4, which includes:
said second benefit category having a limit amount control.

6. The benefit plan system according to claim 5, which includes:
a third benefit category including deductible amount, limit amount and coinsurance percentage controls; and
said second and third benefit category limit amount controls being independently variable.

7. The benefit plan system according to claim 3, which includes:
a supplemental benefit including an attachment point representing an incurred expense amount greater than or equal to at least one of said limit controls; and
said supplemental benefit becoming applicable at said attachment point.

8. The benefit plan system according to claim 7, which includes:
said first benefit category comprising professional health care services including health care professional office visits and including copay and limit amount controls;
said second benefit category comprising health care treatment and including deductible amount, coinsurance percentage and limit amount controls; and
a third benefit category comprising prescriptions and including copay amount, coinsurance percentage and limit amount controls.

9. The benefit plan system according to claim 8, which includes:
a variable premium; and
one or more of said controls being variable by a policyholder, an insured or a beneficiary under said plan; and
said premium being variable in relation to said controls.

10. The benefit plan system according to claim 9, which includes:
a preferred provider network of benefit providers; and
in-network and out-of-network health care provider options selectable by the beneficiary; and
more favorable controls being applicable to in-network healthcare providers.

11. The benefit plan system according to claim 10, which includes:
benefit allocations being based on either health care services provided or conditions being treated.

12. A method of providing healthcare insurance benefits with variable controls, which comprises the steps of:
selecting multiple benefit categories based on either health care service type or beneficiary medical condition;
applying a limit amount control to at least one of said benefit categories;
applying a deductible amount control to at least one of said benefit categories;
applying a coinsurance percentage control to at least one of said benefit categories; and
applying a copay amount control for at least one of said benefit categories.

13. The method according to claim 12, which includes the additional steps of:
selecting a catastrophic attachment point (CAP) comprising an incurred health care treatment expense amount greater than or equal to at least one of said limit amount controls; and
providing major medical healthcare benefits in excess of said limit amount controls upon reaching said CAP.

14. The method according to claim 13, which includes the additional steps of:
selecting multiple major medical benefit categories;
assigning limit amount controls to said major medical benefit categories;
assigning deductible amount controls with start and stop points to said major medical benefit categories;
assigning coinsurance percentage controls with value, start and stop points to said major medical benefit categories; and
assigning copay amount controls to said major medical benefit categories.

15. The method according to claim 14, which includes the additional steps of:
including within said limited medical benefit categories professional services, facilities and prescriptions; and
including within said major medical benefit categories professional services, facilities and prescriptions.

16. The method according to claim 12, which includes the additional steps of:
determining eligibility of multiple potential beneficiaries for said benefits;
defining a group of eligible said beneficiaries;
confirming regulatory compliance for limited and major medical benefits categories;
determining and assigning a preferred provider organization (PPO);
processing potential beneficiary applications for said benefits by obtaining agent data, client data, insured data and proposal data; and
enrolling said insureds in a plan comprising said healthcare benefits.

17. The method according to claim 16, which includes the additional steps of:
negotiating with healthcare providers for health care services within said benefit limit amount controls.

18. The method according to claim 12, which includes the additional steps of:
providing said limited benefits without medical underwriting; and
medically underwriting said major medical benefits.

19. The method according to claim 12, which includes the additional steps of:
determining if a deductible amount control is waived;
determining if a deductible amount control is met;
determining if a healthcare provider is in-network or out-of-network;
decreasing the coinsurance benefit percentage in response to an out-of-network healthcare provider;
determining if a yearly maximum benefit control has been reached;
determining if a lifetime maximum benefit control has been reached; and
applying major medical coverage in the event a catastrophic attachment point (CAP) corresponding to incurred expenses has been reached individually or cumulatively for multiple beneficiaries.

20. A method of providing healthcare insurance benefits with variable controls and insured involvement in procuring healthcare, which comprises the steps of:
selecting multiple limited medical benefit categories based on either health care service type or beneficiary medical condition;
selecting a limit amount control for at least one of said benefit categories;
selecting a deductible amount control for at least one of said benefit categories;
selecting a coinsurance percentage control for at least one of said benefit categories;
selecting a copay amount control for at least one of said benefit categories selecting a catastrophic attachment point (CAP) greater then said limit amounts and comprising an incurred health care treatment expense amount;
providing supplemental healthcare benefits in excess of said limit amount controls upon reaching said CAP;
selecting multiple major medical benefit categories;
assigning limit amount controls to said major medical benefit categories;
assigning deductible amount controls with start and stop points to said major medical benefit categories;
assigning coinsurance percentage controls with value, start and stop points to said major medical benefit categories;
assigning copay amount controls to said major medical benefit categories;
including within said limited medical benefit categories professional services, facilities and prescriptions;
including within said major medical benefit categories professional services, facilities and prescriptions;
determining eligibility of multiple potential beneficiaries for said benefits;
defining a group of eligible said beneficiaries;
confirming regulatory compliance for limited and major medical benefits categories;
determining and assigning a preferred provider organization (PPO);
processing potential beneficiary applications for said benefits by obtaining agent data, client data, insured data and proposal data;
enrolling said insureds in a plan comprising said healthcare benefits;
negotiating with healthcare providers for health care services within said benefit limit amount controls;
providing said limited benefits without medical underwriting; and
medically underwriting said major medical benefits.
